(19) United States
(12) Patent Application Publication
(10) Pub. No.: US 2010/0299156 A1
(43) Pub. Date: Nov. 25, 2010

(54) HEALTH CARE MANAGEMENT AND PATIENT EDUCATION SYSTEMS AND METHODS

(76) Inventor: Douglas J. Jorgensen, Manchester, ME (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/469,159

(22) Filed: May 20, 2009

(51) Int. Cl. G06Q 50/00; G06Q 30/00; G06Q 40/00; G06Q 10/00

(52) U.S. Cl. 705/3; 705/2; 705/34; 705/4; 705/39; 434/262; 705/326

(57) ABSTRACT

Health care management and patient education systems and methods configured to register a medical practice account, add patients to the account, create patient-accessible accounts, add medical and lecture providers to the account, create patient education seminars, invite patients to seminars, create patient report cards, and reporting patient report cards to a patient outcome incentive-based program.

### FIELD OF THE INVENTION

The present invention relates generally to health care systems and methods for improving patient outcomes through education, and more particularly, to web-based systems and methods utilized by medical providers to manage patient information, educate patients regarding disease and treatment, and report the participation and success of patient education programs. The systems and methods provided herein advantageously reduce health care costs by improving patient outcomes. The systems and methods provided herein may be deployed in performance- and reporting-based medical provider incentive programs.

### BACKGROUND OF THE INVENTION

Insurance companies, health care providers and patients are persistently looking for ways to mitigate ever-increasing health care costs. In this regard, initiatives are now being undertaken to help medical providers gain results on their patient treatments by combining outcomes with incentives. One such initiative includes the Physician Quality Reporting Initiative (PQRI) undertaken by the Center for Medicare and Medicaid Services (CMS). Through PQRI reporting, practice and providers can earn commissions for reporting and performance, encouraging them to follow standardized approaches toward patient treatment and reporting.

In conventional treatment approaches, patients suffering from a disease are typically treated by a physician and educated during that same in-person visit with regard to the disease, treatments and preventative medicine. A physician's time is valuable and in demand, and it is often not possible, practical or cost-effective to educate a patient with regard to the above during an in-person visit. In this regard, it would be desirable to allow a physician to see and treat a greater number of patients throughout the day and provide the corresponding education at a later time, such as through a patient-attended educational seminar lectured by a qualified professional, or through patient self-education reviewing supplied materials. To further support this method of treatment, medical providers are often specialists, treating multiple patients with the same disease and treatment strategy, making consolidated education all the more possible and practical.

To implement such an educational strategy, there exists a need for a tool with which medical providers could store patient information, organize educational seminars, invite attendees, report patient comprehension, and report compliance with standardized approaches toward patient treatment and reporting. To satisfy this need, the present invention provides web-based tools in which medical providers and lecture providers are brought together to provide educational services to patients to improve patient outcomes. Further, the present invention provides web-based tools in which authorized patients are provided access to predetermined modules within the tools to manage personal information and view data.

### BRIEF SUMMARY OF THE INVENTION

To achieve the foregoing and other advantages, it is an object of the invention to reduce health care costs and improve patient outcomes through education.

It is another object of the invention to systematically manage and evaluate a patient's health records while providing education on an ongoing basis.

It is a further object of the invention to provide a shared health care management system in which medical providers, lecture providers and patients are brought together to educate patients to improve patient outcomes.

It is a further object of the invention to provide systems and methods for storing patient data, establishing educational seminars relating to patient conditions (i.e., disease), inviting patients to attend educational seminars, evaluating educational effectiveness, and providing ongoing education.

It is a further object of the invention to provide a subscription-based health care management system.

It is a further object of the invention to provide a web-based health care management system for medical providers in which an account holder can manage their profile, modify billing information, add/remove medical and lecture providers, create and manage educational seminars, invite patients to seminars, generate report cards, submit PQRI reports, and report data, among other functions.

It is a further object of the invention to provide a health care management system for storing patient information in a HIPPA secure manner.

It is a further object of the invention to provide a health care management system optionally including patient accessibility.

It is a further object of the invention to provide a health care management system for storing patient baseline values, ongoing patient values and report card data.

It is a further object of the invention to provide a health care management system for creating education seminars administered by registered lecture providers.

It is a further object of the invention to compare patient baseline values to ongoing values to determine seminar effectiveness and corresponding courses of action to be taken by medical providers.

It is a further object of the invention to provide PQRI compliant systems and methods in which medical providers earn commissions based on reporting and performance.

It is a further object of the invention to provide a health care management system in which a provider patient may opt out of participation in the system or certain aspects of participation in the system, thus indemnifying the provider and optionally instituting a higher premium or co-pay for that patient for non-compliance.

These and other objects of the present invention are achieved in the preferred embodiments disclosed below by providing a health care management and patient education system configured to: register an authorized medical practice account at the request of a medical practice; add patients having a predetermined condition to a registered medical practice account; create patient-accessible accounts for managing personal information and viewing health records stored in the registered medical practice account; add medical and lecture providers to the registered medical practice account; create a patient education seminar; invite patients to attend the seminar based on patient health data; create patient report cards to determine the understanding of the patients attending the seminar; and reporting patient report cards to a patient outcome incentive-based program.

According to another embodiment, the system is a subscription-based system further configured to calculate a registered medical practice account subscription fee based on a number of providers in the medical practice, and a subscription-based system further configured to bill a registered medical practice account based on the number of patient report cards created during a predetermined period.

According to another embodiment, the system web-based accessible computer program product for deployment in the Physician Quality Reporting Initiative undertaken by the Center for Medicare and Medicaid Services.

According to another embodiment, the system includes a user module for storing registered medical practice account data, an administration module associated with the user module for system administration, a credit card module associated with the user module for storing billing information, and a user transaction module associated with the user module for storing account transactions.

According to another embodiment, the system includes an education module including a patient module for storing patient data, a user module for storing registered medical practice account data; a provider module associated with the user module for storing provider data; a seminar module associated with the provider module for creating the seminars; and a report card module associated with the patient module for creating the report cards.

According to another embodiment, the system includes a reporting module including a patient module for storing patient data; a reports module associated with the patient module for creating reports; and a user module associated with the patient and reports module for storing registered medical practice account data.

In another embodiment, the present invention provides a method for health care management and patient education including the step of: providing a web-based computer program product configured for creating a medical practice account at the request of a medical practice, adding patients to the medical practice account, creating patient-accessible accounts for managing personal information and viewing health records, adding medical and lecture providers to the medical practice account, creating patient education seminars, inviting patients to attend seminars, creating patient report cards on seminar understanding, and reporting patient report cards to a patient outcome incentive-based program.

### BRIEF DESCRIPTION OF THE FIGURES

Features, aspects and advantages of the present invention are understood when the following detailed description of the invention is read with reference to the accompanying drawings, in which:

FIG. 1 is a flow diagram illustrating a module for enrolling a medical practice into the system according to an embodiment of the invention;

FIG. 2 is a flow diagram illustrating a module for calculating provider participation charges according to an embodiment of the invention;

FIG. 3 is a flow diagram illustrating a module for adding a new patient according to an embodiment of the invention;

FIG. 4 is a flow diagram illustrating a module for creating a patient account according to an embodiment of the invention;

FIG. 5 is a flow diagram illustrating a module for adding a new provider to a practice according to an embodiment of the invention;

FIG. 6 is a flow diagram illustrating a module for creating an educational seminar according to an embodiment of the invention;

FIG. 7 is a flow diagram illustrating a module for adding patients to a seminar according to an embodiment of the invention;

FIG. 8 is a flow diagram illustrating a module for report card charging according to an embodiment of the invention;

FIG. 9 is a flow diagram illustrating a module for PQRI reporting according to an embodiment of the invention;

FIG. 10 is a block diagram illustrating a user module according to an embodiment of the invention;

FIG. 11 is a block diagram illustrating an education module according to an embodiment of the invention; and

FIG. 12 is a block diagram illustrating a PQRI (Physician Quality Reporting Initiative) module according to an embodiment of the invention.

### DETAILED DESCRIPTION OF THE INVENTION

The present invention will now be described more fully hereinafter with reference to the accompanying figures in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

### System Overview

Referring to the figures, the present invention provides systems and methods for systematically managing patient health records and increasing patients outcomes through education. The systems and methods described herein are intended to supplement treatment, thus reducing health care costs by providing health planning and education. In preferred embodiments, the systems are web-based accessible by medical providers and optionally by lecture providers and patients. The systems are further configured to manage patient health records, and reduce health care costs associated with at least the following diseases/conditions: hypertension; diabetes; asthma/COPD; cholesterol; anticoagulation; and cancer.

As will be appreciated by those skilled in the art, the present invention may be embodied as a tool, a method, a data processing system, a computer program product, and a web-based software application. Accordingly, the present invention may take the form of an embodiment combining software and hardware aspects. Furthermore, the present invention may take the form of a computer program product on a computer-readable storage medium having computer-readable program instructions (e.g., software application) embodied in the storage medium. More particularly, the present invention may take the form of web-implemented computer software. Any suitable computer-readable storage medium known to those skilled in the art may be utilized including, but not limited to, hard disks, CD/DVD-ROMs, optical storage devices and magnetic storage devices.

The present invention is described below with reference to flow and block diagrams illustrating methods, apparatuses (i.e., systems) and computer program products according to preferred embodiments of the invention. It will be understood that each block of the diagrams, and combinations of blocks in the diagrams, respectively, can be implemented by computer program instructions. These computer program instructions may be loaded onto a server, special purpose computer or other programmable data processing apparatus to produce a machine, such that the instructions that execute on the computer or other programmable data processing apparatus create a means for implementing the functions specified in the flow and block diagrams.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flow and block diagrams. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flow and block diagrams.

Accordingly, blocks of the diagrams support combinations for performing the specified functions, combinations of steps for performing the specified functions and program instructions for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

### System Modules and Methods

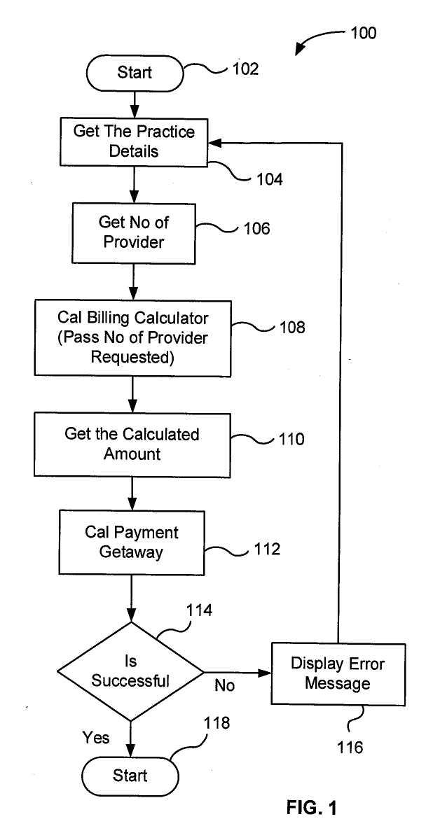

The process begins with the registration of a medical practice into the system. Referring to FIG. 1, a flow diagram illustrating a module and method for enrolling a medical practice into the system according to an embodiment of the invention is shown generally at 100. A medical practice of any qualifying size and type may sign up for an account for a predetermined time period based on the program agreement. Medical practice account registration begins at Step 102, when the medical practice enters practice details, Step 104, including, but not limited to, practice name, practice type, contact information, Federal Tax ID, user ID, passwords, password confirmation, promotional codes. The medical practice must further acknowledge understanding of program agreements and policies. Upon completion of required and optional fields, a practice number is assigned, Step 106. Subsequently, provider billing is calculated according to plan participation, Step 108, and a calculated amount determined, Step 110, and verified, Step 112. An incorrect registration or calculation results in a display error message, Step 116, resulting in a repeat of Steps 104-114. A successful registration results in the practice registration being complete, Step 118. Once complete, account owners are able to perform the following exemplary functions: managing personal profiles; modifying billing information; adding/removing medical lecture providers; creating and managing seminars; adding and inviting patients to attend seminars; creating, modifying and printing report cards; submitting PQRI report cards; and, data reporting.

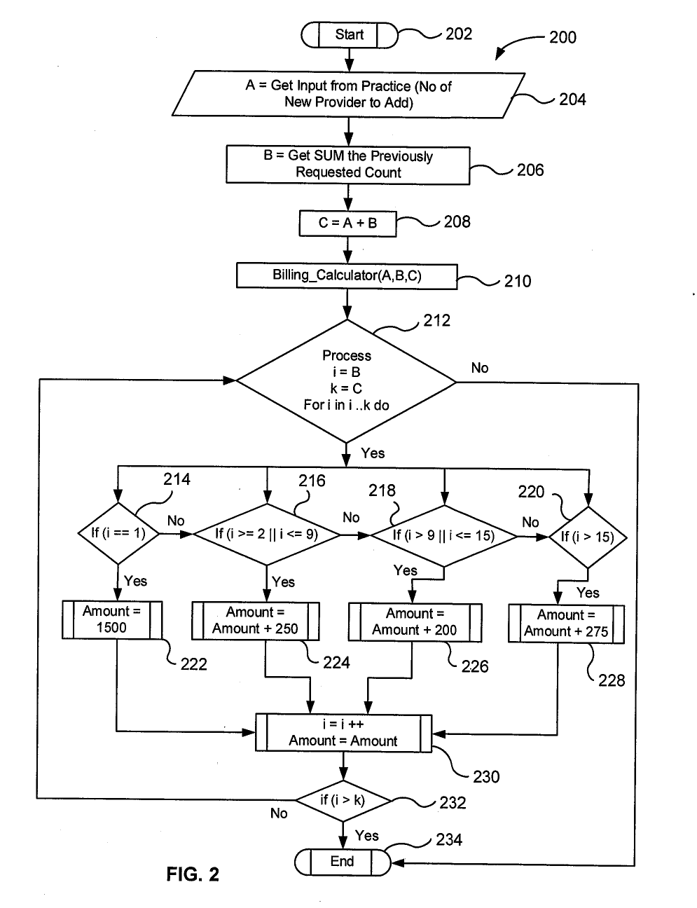

In a program in which medical practice participation costs directly correlate to the total number of participants in the medical practice, the next step includes calculating provider charges for plan participation. Referring to FIG. 2, a flow diagram illustrating a module and method for calculating provider participation charges according to an embodiment of the invention is shown generally at 200. Beginning at Step 202, the number of a new practice to add is obtained, Step 204. The sum of providers in that practice is then obtained, Step 206. The two preceding values are then summed to obtain a value, Step 208, and entered into a billing calculator, Step 210, where subscriber fees are determined, Step 212. In an exemplary billing structure, a program including a single participant returns a basic subscription amount, Step 222, a program including 3-9 participants may return a basic subscription amount plus an amount for each provider, Step 224, a program including 9-15 participants may return the basic subscription amount plus an additional decreased amount per provider, Step 226, and a program including greater than 15 participants may return a basic subscription amount plus a further decreased amount per provider, Step 228. Thus, subscription fees include a basic participation fee plus a predetermined amount for each provider in a practice, that may be discounted as the provider number increases. Referring to Step 230, amounts may be calculated by determining the number of providers in a practice being registered. A greater value in Step 230 as compared to Step 208 results in a recalculation, Step 232. Once approved, the provider charge calculation is complete, Step 234.

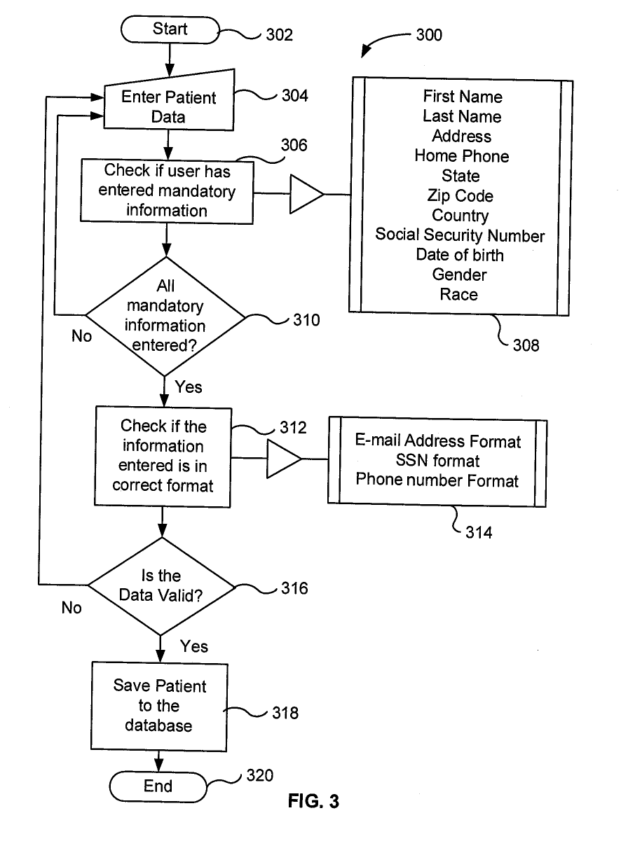

A next step in the system includes storing patient information in a systematic and secure manner, such as conforming to HIPAA requirements. The system stores personal information and primary health data for each patient. Primary health data may include at least laboratory measured baseline values for reference with later obtained values. Referring to FIG. 3, a flow diagram illustrating a module and method for adding a new patient according to an embodiment of the invention is shown generally at 300. The process begins at Step 302 with the user entering appropriate patient data, Step 304. A check is run to determine if the user has entered the data into the mandatory fields, Step 306, which is shown in Step 308. A query is run to determine if the data has been properly entered, Step 310. A return of “NO” redirects the user to repeat Step 304. A return of “YES” then directs to a prompt to determine if the data is in the correct format, Step 312, such as email address format, social security number format and phone number format, Step 314. A query, Step 316, returning a “NO” redirects the user to Step 304. A return of “YES” instructs the system to store the patient information, Step 318, and ends the process for adding a patient, Step 320. The process is repeated for each new patient.

Patient data may further include patient acknowledgement of participation/non-participation in certain diagnostics, patient education programs and other programs. While all patients of a provider may be entered into the system for patient management, it is envisioned that certain patients may desire to remain with a provider while opting out of the education and reporting system. Those patients may be classified as “non-compliant” or “non-participating.” “Compliant” or “participating” patient status prompts entry into the system for patient education and optionally the creation of a patient accessible account as described in detail below. Refusal to participate in the systems of the present invention, or portions of the system, may optionally indemnify or hold harmless the provider as it relates to system compliance and reporting. Non-participating patients may prompt the provider to charge more for patient treatment by that provider, such as in the form of higher co-pays, higher premiums, etc., thus providing a patient disincentive for non-participation. The documentation of a patient's refusal to participate may be captured in a system producible form, referred to herein as a “Quality Metrics Defense Agreement.” Patient compliance with the systems described herein may be changed at any time by accessing the patient module and changing the status from “compliant” to “non-compliant,” and vice-versa.

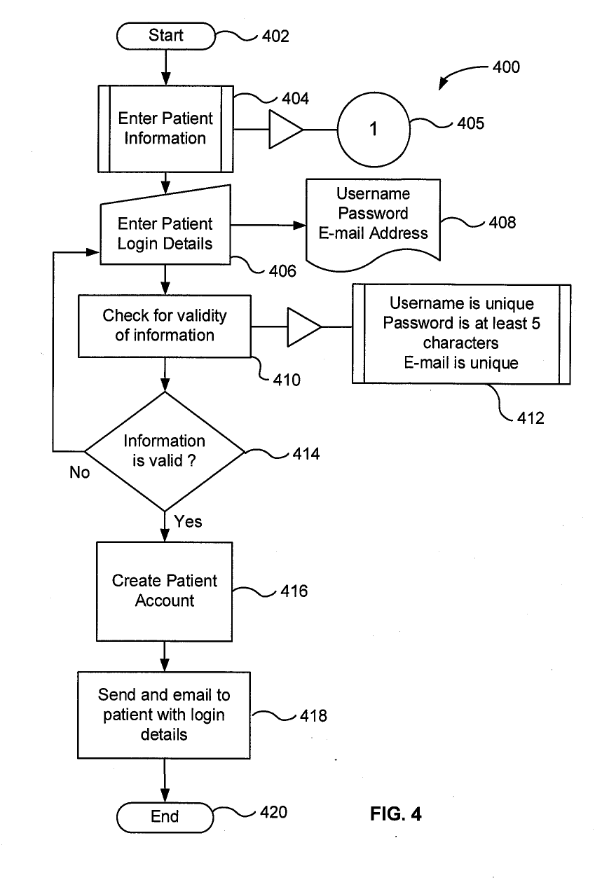

A registered medical provider has the option of allowing a complaint patient to create a patient account for viewing/updating their personal information, as well as viewing their health records. Referring to FIG. 4, a flow diagram illustrating a module and method for creating a patient account according to an embodiment of the invention is shown generally at 400. The process begins at Step 402 when the practice enters patient information, Step 402, such as an assigned patient number, Step 405. Patient login details are then entered, Step 406, including username, password and email address, Step 408. Validity of the information is checked, Step 410, such as a unique username, password of appropriate predetermined character length and unique email address, Step 412. A query is then run to determine if the information is valid, Step 414. A return of “NO” redirects the user to reenter patient login details, Step 406. A return of “YES” instructs the system to create a patient account, Step 416, and an email is sent to the patient's on-file email address with login details, Step 418, to complete the process, Step 420. Patient accounts may be created for each patient of a medical provider at the request of the provider. With account access, a patient has the ability to modify their personal profile, modify their username, email and password, view/print report cards, and view health records.

The system is configured to manage both medical and lecture providers, and provides each account with the ability to manage lecture providers into their account. Providers may be classified into two types: medical providers and lecture providers. Medical providers are classified as providers that possess a recognized medical graduate degree and national provider education number (NPI). Such providers are paid providers, meaning that they are added based on the subscription plan account that the owner has subscribed to. Lecture providers are classified as any provider that conducts patient seminars but does not provide medical services to patients. Under this classification, it is possible for a “non-practicing” or “non-participating” medical provider to be classified as a lecture provider.

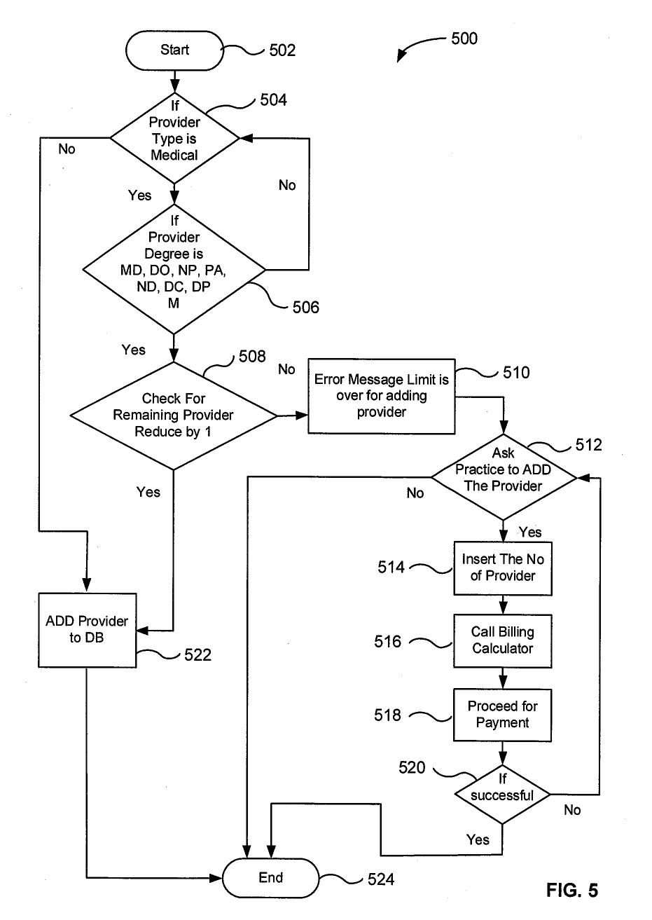

Referring to FIG. 5, a flow diagram illustrating a module and method for adding a new provider to a practice according to an embodiment of the invention is shown generally at 500. The process begins at Step 502 with a determination whether or not the provider type is medical, Step 504. A query returning a “NO” answer adds the provider to a database for non-medical providers, Step 522, and ends the medical provider account registration process at Step 524. A query returning a “YES” answer prompts a query to determine an appropriate approved educational degree, Step 506. An answer returning a “NO” to the appropriate degree type returns the registrant to the medical provider prompt, Step 504, where the medical provider question is repeated. A query returning a “YES” answer to the degree prompt directs the registrant to registered providers, Step 508. A “NO” answer to the check directs the registrant to an error message, Step 510, where the practice is asked to add the provider, Step 512. A “NO” answer to the query directs the registrant to the end of the registration process Step 524. A “YES” answer to the query directs the registrant to insert a provider number, Step 514, call up the billing calculator, Step 516, proceed for payment, Step 518, and then run a check to determine if the provider was successfully added, Step 520. Unsuccessful addition returns the user to Step 512. Successful addition ends the process, Step 524.

Once an account has been created and patients and lecture providers entered, the account owner may create seminars intended to educate patients with respect to conditions. Seminars invitees are preferably chosen based on common conditions. A user can further invite (add) patient to seminars and create report cards associated with the seminars to determine patient understanding of the material. Resources and templates for creating seminars and creating report cards are stored in the system and are available with instructions for completion.

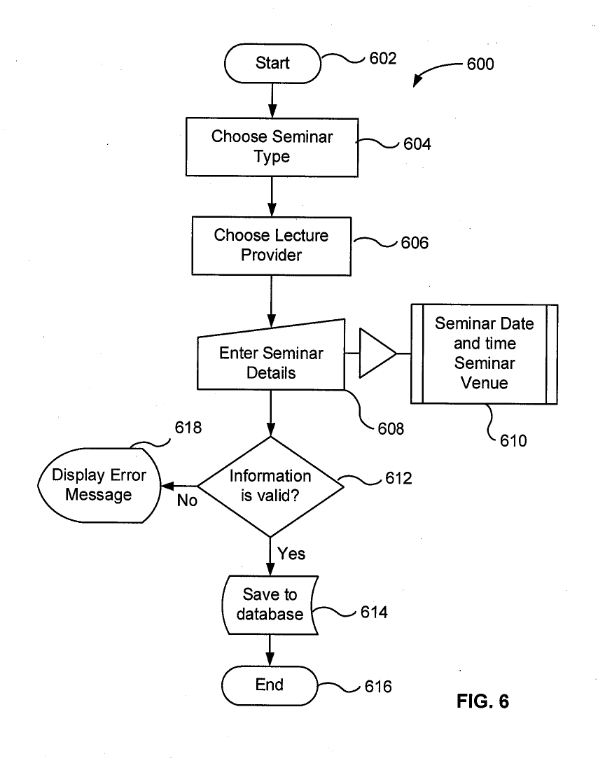

Referring to FIG. 6, a flow diagram illustrating a module and method for creating an educational seminar according to an embodiment of the invention is shown generally at 600. The process begins at Step 602 when the user chooses a seminar type, Step 604. Seminar type may refer to both seminar subject matter as well as seminar types including live seminars, web seminars and patient self-education materials. Once the seminar type is selected, the user chooses a lecture provider from the database of providers, Step 606. Next, seminar details are added, Step 608, including seminar date, time and venue, Step 610. A query is then run to determine if the entered information is valid, Step 612. Invalid information returns an error message, Step 618. Valid information prompts the system to save the seminar in the database, Step 614, and ends the seminar creation process, Step 616.

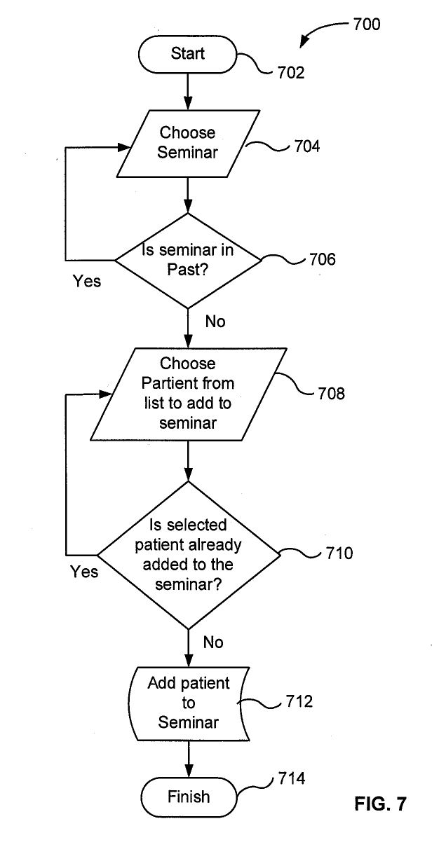

Referring to FIG. 7, a flow diagram illustrating a module and method for inviting (adding) patients to a seminar according to an embodiment of the invention is shown generally at 700. The process begins at Step 702 by choosing a saved seminar, Step 704. A query is then run to see if the chosen has already taken place. A return of a “YES” prompts the user to select another seminar from the database. A return of “NO” prompts the user to choose patients from their stored patient lists to add patients to the seminar, Step 708. A query is then run to determine if selected patients have previously been added, Step 710. A return of “YES” prompts the user to return to Step 708 to make additional or remove selected patients. A return of “NO” results in the patient being added to the seminar invitation list, Step 712, and ends the process, Step 714.

The system is further configured to generate report cards. Once a patient is added to a seminar, a report card is created and optionally printed by the practice corresponding to each patient attending that seminar. In each report card, a patient's health data is recorded and maintained separately from the baseline value data. As a result, with each seminar attendance, as the new report cards are generated a patient's progress can be tracked and corresponding courses of action can be taken by the medical provider. Data entered into a report card may vary depending upon the type of seminar being attended by the patient. Data may include, but is not limited to, vitals and lab-measured values, among others. At the conclusion of a seminar, patients are provided with a “quiz” associated with the seminar to ascertain their understanding of the material. Adding/modifying a quiz is fully dynamic and controlled by the site administration.

For each created report card, the account owner (practice) may be charged a predetermined amount, for example $5/report card. At the end of a predetermined time period, for example a month, the account owner (practice) is charged for all report cards generated during that time period. In a specific embodiment, an account owner may only be charged for that time period should the total exceed a predetermined amount, for example $100 or 20 report cards. Amounts lesser than the threshold may carry over to the next time period. A report card creation and charge history is maintained for each practice account.

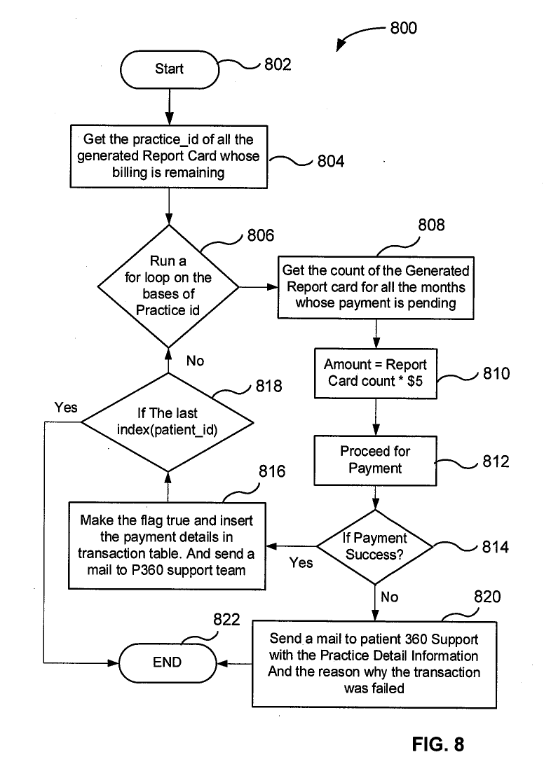

Referring to FIG. 8, a flow diagram illustrating a module and method for report card charging according to an embodiment of the invention is shown generally at 800. The process begins at Step 802 with obtaining the practice ID for all generated repot cards with remaining billing, Step 804. A loop is then run on the basis of practice ID to ensure all report cards have been accounted for, Step 806. The count of the generated report cards for all predetermine time periods whose payment is pending is obtained, Step 808. That count is then used to calculate an amount (e.g., amount=count×$5), Step 810. The amount is then processed for payment, Step 812. A successfully processed payment is entered into the practice transaction details, Step 816, and indexed against the ID to complete the process, Step 822. An unsuccessfully processed payment results in an error message being site to the site administrator with data regarding why the transaction failed, Step 820, the process is then complete, Step 822.

The final step in the process is PQRI reporting. As stated above, PQRI is an incentive-based program for rewarding providers based on patient outcomes and reporting. The systems and methods provided herein may be implemented as an authorized registry for entering PQRI reports. PQRI reports may be submitted during particular reporting periods. Exemplary reportable measure groups include, among others: diabetic measure group; universal weight screening and follow up; colorectal cancer screening; and universal documentation and verification of current medical records. A variety of data reporting criteria may be available under this system to track health statistics of patients within a practice, some of which include: number of patients with a specific condition/disease; average laboratory values; demographic information; smoker information; pneumovacc/HPI med report; patient seminar attendance report; and custom queries.

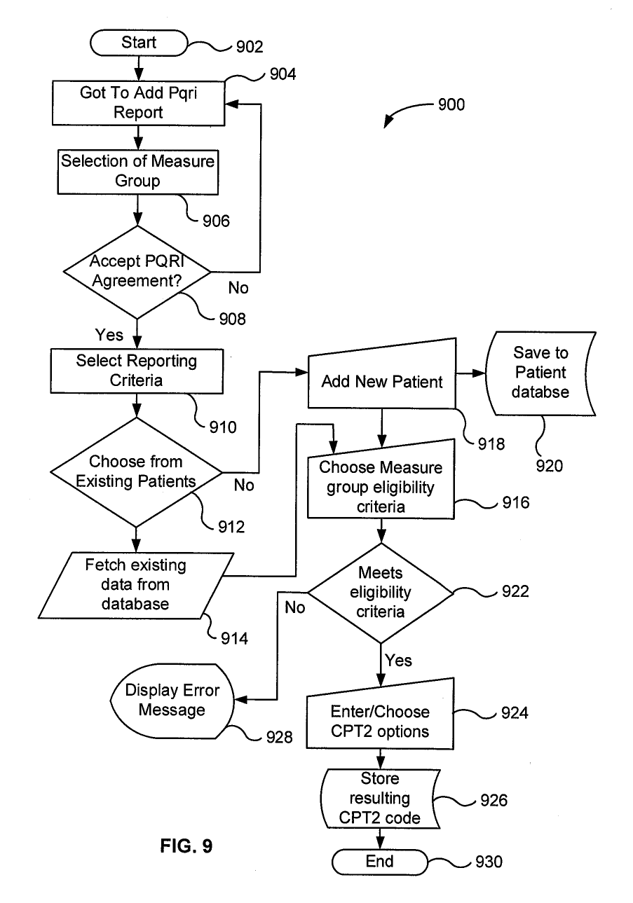

Referring to FIG. 9, a flow diagram illustrating a module and method for PQRI reporting according to an embodiment of the invention is shown generally at 900. The process beings at Step 902 when a user requests to add a PQRI report, Step 904. The specific group measure to report is then selected from a list of group measures, Step 906. The PQRI agreement is then accepted or declined, Step 908. Declining the agreement returns that user to Step 904 where the user chooses to add a PQRI report. Accepting the agreement prompts the user to then select reporting criteria, Step 910. The user then chooses from existing patients, Step 912. In the case of existing patients, data is recovered from the existing patient database, Step 914. In the case of a new patient, the patient is added, Step 918, and saved to the patient database, Step 920. Whether the patient is existing or newly added, the next step in the process includes choosing measure group eligibility criteria, Step 916. A query is run to determined if the report meets eligibility criteria, Step 922. A report that does not meet eligibility criteria returns an error message to the user, Step 928. A report that meets the eligibility criteria prompts the user to enter/choose reporting options, Step 924. The report is then stored and assigned a reporting code, Step 926, completing the PQRI reporting process, Step 930.

### System Architecture

A system for implementing the above modules and methods according to one embodiment of the present invention includes medical provider computers or other interface devices in communication with a patient management and education system operating on a server. Access to the server is preferably web-based. The system is configured for at least entering, receiving, storing, arranging, manipulating, generating, accessing, retrieving and reporting data.

The system includes an operating system and a processor that communicates with other elements within the system via a system interface or bus. Also included in the system is a display device/input device for receiving, inputting and displaying data. The system further includes memory, which preferably includes both read only memory (ROM) and random access memory (RAM). The system's ROM is used to store a basic input/output system (BIOS), containing the basic routines that help to transfer information between elements within the system. Alternatively, the claims processing system can operate on one computer or on multiple computers networked together.

In addition, the system includes at least one storage device, such as a hard disk drive, a CD/DVD Rom drive or optical disk drive, for storing information on various computer-readable media, such as a hard disk, a removable magnetic disk or a CD/DVD-ROM disk. As will be appreciated by skilled in the art, each of these storage devices is connected to the system bus by an appropriate interface. The storage devices and their associated computer-readable media provide nonvolatile storage for a personal computer.

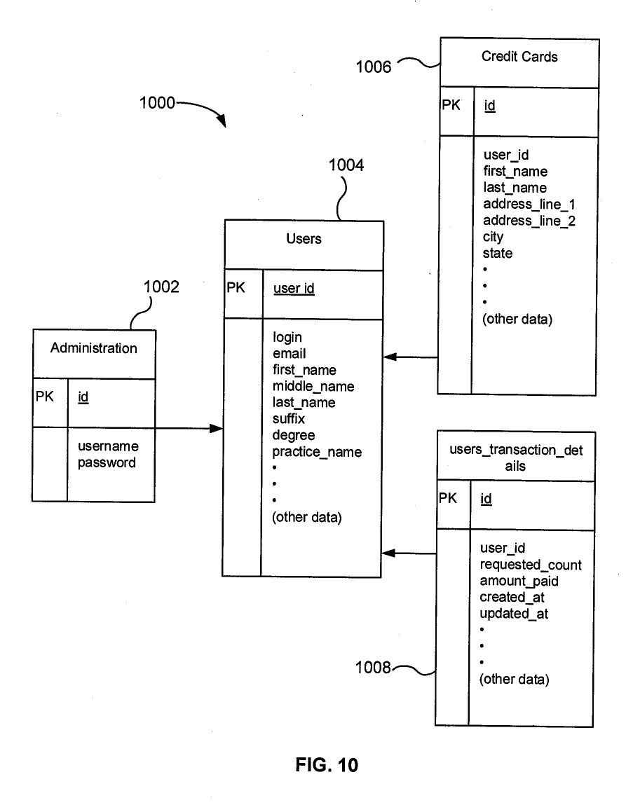

Application modules are stored by the various storage devices and within RAM. Referring to FIGS. 10-12, application modules of the system include at least a user module 1000, an education module 1100, and a PQRI module 1200 in communication and cooperation. The application modules are used to control certain aspects of the operation of the system with the assistance of the processor and an operating system.

### User Module

Referring to FIG. 10, a block diagram of a user application module 1000 according to one embodiment of the present invention is shown. The module includes a user module 1004 associated and in communication with an administration module 1002, a credit card module 1006 and a user transaction details module 1008. Secure access to the administration module 1002 is granted through a username and password login. The administration module 1002 is operable for administration over each medical provider account. The user module 1004 is accessed through a user id and includes essential account information such as login, email, name, practice name, practice type, address, contact numbers, passwords, service agreement, account balance and account start and expiration date data. The credit card module 1006 associates subscription payment information with user accounts and stores data including, but not limited to, user id, name, address, contact numbers, and credit card information. The user transaction details module 1008 links subscription payments, payment history and other transaction details with the appropriate user account(s).

### Education Module

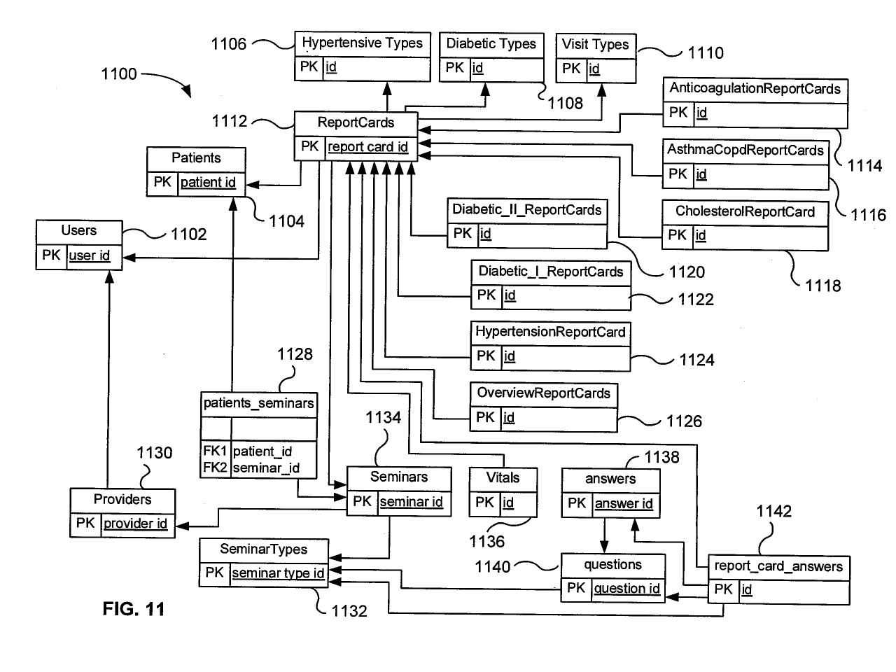

Referring to FIG. 11, a block diagram of an education application module 1100 according to one embodiment of the present invention is shown. The module 1100 generally includes user, patient, provider, seminar and report card modules in communication to link and send/receive data between patients, providers, seminars and report cards and user accounts. A predetermined user account 1102 (a similar exemplary user account is illustrated in FIG. 10 at 1004) communicates with each module of the application through a provider module 1130 and report card module 1112. The provider module 1130 includes data such as user id, name, degree and provider type. The report card module 1112 includes data such as report card id, patient id, visit type, medical conditions, vitals, medications, preexisting conditions, lifestyle, seminar id and user id. Educational seminar effectiveness for patients is determined by the report card module data obtained by a cooperative reporting effort from a variety of modules, as described below in detail.

The provider module 1130 is in communication with a seminar module 1134 that includes data such as provider id, user id, location, start, paid and seminar types. The seminar module 1134 communicates with a seminar type module 1132 that includes data such as seminar type id, name and active status. The seminar type module 1132 further communicates with associated question module 1140, answer module 1138 and report card answer module 1142, which collectively communicate with the report card module 1112. The questions module 1140 includes data such as questions, creation dates, deletion dates and seminar type ids. The answer module 1138 includes data such as question id, answer, creation dates and deletion dates. The report card answers module 1142 includes data such as report card id, seminar type id, question id and answer id. The modules 1140, 1138 and 1142 associate questions, answers and report card answers with seminar types.

Seminars are established from seminar types and patient seminars are created with patient seminar module 1128, which includes data such as patient id and seminar id. Seminars are linked with invited patient ids obtained from a patient module 1104. Patient module 1104 is organized by patient ids and includes essential data such as legal name, gender, race, address, contact information, birth date, email, social security number, dated deceased, passwords, account creation/update dates, vitals, baseline values, test results, conditions, etc. Data recorded and managed in patient accounts is used to identify patients by searching criteria, identify patients for seminars, grouping patients and sending attendance invitations, as well as other functions. The patient module 1104 is in further communication with the report card module 1112, which creates reports based on educational seminar effectiveness.

The report card module 1112 is in further communication with a vitals module 1136, as well as exemplary types modules including hypertensive types module 1106, diabetic types module 1108 and visit types module 1110, which include name and predetermined code data. The vitals module 1136 includes data such as systolic blood pressure, diastolic blood pressure, cholesterol levels triglycerides, lab-measured values as well as any other patient data. The report card module 1112 is in further communication with exemplary condition report card modules, such as anticoagulation report card module 1114, asthma report card module 1116, cholesterol report card module 1118, diabetic type I report card module 1120, diabetic type II report card module 1122, hypertension report card module 1124 and an overview report card module 1126. The preceding modules represent exemplary tracked conditions for implementation with the system, and it is envisioned that the systems and methods may include additional and/or alternative tracked conditions and associated modules.

The anticoagulation report card module 1114 includes data such as report card id for linking with a patient id, as well as lab-measured values. The asthma report card module 1116 includes data such as shot records, hospitalization records, symptoms as well as lab-measured values. The cholesterol report card module 1118, diabetes report card modules 1120 and 1122, and hypertension report card module 1124 include data such as lab-measured values. The These modules function to store and manage data reported to the report card module 1112 to assess progress effectiveness by directly linking patient condition data with report cards.

### PQRI Module

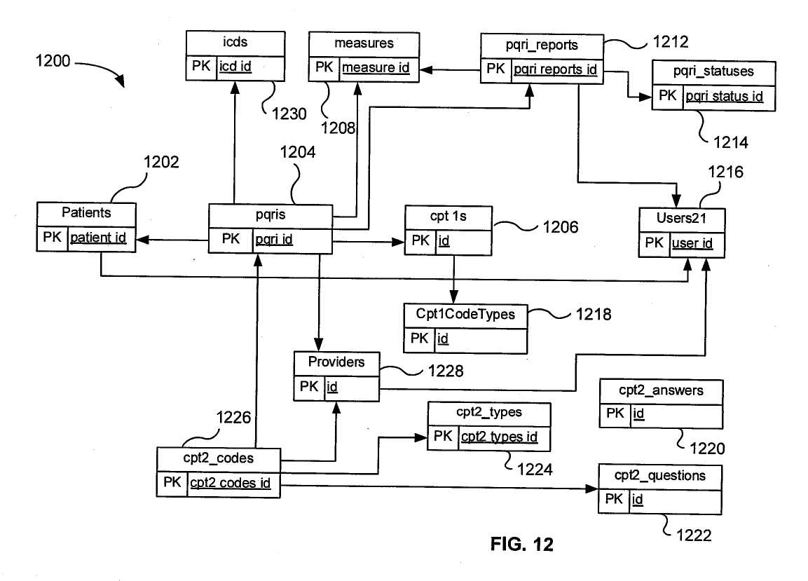

Referring to FIG. 12, a block diagram of a PQRI application module 1200 according to one embodiment of the present invention is shown. As stated above, PQRI is an exemplary reporting and outcome-based incentive program, and it will be appreciated by those skilled in the art that the PQRI application module 1200 may be modified to adapt to and implement other incentive-based programs. The PQRI application module 1200 generally functions to produce PQRI-compliant report cards for account users based on patient outcomes determined through measured criteria. The PQRI report cards may then be used to determine medical provider incentives based on medical provider performance, patient outcomes, and educational results, among other factors.

As shown in FIG. 12, the module 1200 includes a patient module 1202 (a similar exemplary patient module is illustrated in FIG. 11 at 1104) in communication with a PQRI module 1204. The PQRI module 1204 includes data such as results, patient ids, medical provider ids, PQRI reports, status identifiers as well as other incentive determining data and reporting criteria. The PQRI module 1204 is in communication with a provider module 1228 (a similar exemplary provider module illustrated in FIG. 11 at 1130), icd module 1230, measures module 1208, cpt module 1206 and cpt code types module 1218. The PQRI module 1204 is in further communication with a cpt2 codes module 1226 in communication with cpt2 types module 1224, cpt2 answers module 1220 and cpt2 questions module 1222. The PQRI reports module 1212 generates reports based on the predetermined criteria for incentives from the data of measures module 1208 and PQRI module 1204. PQRI status reports are handled by a PQRI status module 1214. PQRI reports are linked to and in communication with a system user account 1216 (a similar exemplary user account is illustrated in FIG. 10 at 1004).

While the preceding systems and methods have been described with reference to specific embodiments and examples, it is envisioned that various details of the invention may be modified without departing from the spirit and scope of the invention. Furthermore, the foregoing description of the preferred embodiments of the invention and best mode for practicing the invention are provided for the purpose of illustration only and not for the purpose of limitation.

What is clamed is:

1. A health care management and patient education system configured to: register an authorized medical practice account at the request of a medical practice; add patients having a predetermined condition to a registered medical practice account; create patient-accessible accounts for managing personal information and viewing health records stored in the registered medical practice account; add medical and lecture providers to the registered medical practice account; create a patient education seminar; invite patients to attend the seminar based on patient health data; create patient report cards to determine the understanding of the patients attending the seminar; and reporting patient report cards to a patient outcome incentive-based program.

2. A system according to claim 1, wherein the system is a subscription-based system further configured to calculate a registered medical practice account subscription fee based on a number of providers in the medical practice.

3. A system according to claim 1, wherein the system is a subscription-based system further configured to bill a registered medical practice account based on the number of patient report cards created during a predetermined period.

4. A system according to claim 1, wherein the system is a web-based accessible computer program product.

5. A system according to claim 1, wherein the system is further configured to a classify providers into medical providers and lecture providers based on medical graduate degree and national provider identification number.

6. A system according to claim 1, wherein the incentive-based program is the Physician Quality Reporting Initiative undertaken by the Center for Medicare and Medicaid Services.

7. A system according to claim 1, wherein the system includes a user module for storing registered medical practice account data, an administration module associated with the user module for system administration, a credit card module associated with the user module for storing billing information, and a user transaction module associated with the user module for storing account transactions.

8. A system according to claim 1, wherein the system includes an education module including a patient module for storing patient data including participation/non-participation, a user module for storing registered medical practice account data; a provider module associated with the user module for storing provider data; a seminar module associated with the provider module for creating the seminars; and a report card module associated with the patient module for creating the report cards.

9. A system according to claim 8, wherein the system is further configured to compare report card data to patient baseline data to determine patient outcome.

10. A system according to claim 1, wherein the system includes a reporting module including a patient module for storing patient data; a reports module associated with the patient module for creating reports; and a user module associated with the patient and reports module for storing registered medical practice account data.

11. A system for managing health care and patient education, comprising:
a user module configured to register an authorized medical practice account at the request of a medical practice, add patients having a predetermined condition to a registered medical practice account, create patient-accessible accounts for managing personal information and viewing health records stored in the registered medical practice account, and add medical and lecture providers to the registered medical practice account;
an education module configured to create patient education seminars, invite patients to attend seminars based on patient health data, and create patient report cards to determine the understanding of the patients attending the seminar; and
a reporting module for reporting patient report cards to a patient outcome incentive-based program.

12. A method for providing health care management and patient education, comprising the step of: providing a web-based computer program product configured for creating a medical practice account at the request of a medical practice, adding patients to the medical practice account, creating patient-accessible accounts for managing personal information and viewing health records, adding medical and lecture providers to the medical practice account, creating patient education seminars, inviting patients to attend seminars, creating patient report cards on seminar understanding, and reporting patient report cards to a patient outcome incentive-based program.

13. A method according to claim 12, wherein registration with the computer based product is subscription-based on the number of providers in the medical practice.

14. A method according to claim 12, wherein the computer program product is further configured to bill a medical practice account based on the number of patient report cards created during a predetermined period.

15. A method according to claim 12, wherein the computer program product is further configured to classify providers into medical providers and lecture providers based on medical graduate degree and national provider identification number.

16. A method according to claim 12, wherein the incentive-based program is the Physician Quality Reporting Initiative undertaken by the Center for Medicare and Medicaid Services.

17. A method according to claim 12, wherein the computer program product includes a user module for storing registered medical practice account data, an administration module associated with the user module for system administration, a credit card module associated with the user module for storing billing information, and a user transaction module associated with the user module for storing account transactions.

18. A method according to claim 12, wherein the computer program product includes an education module including a patient module for storing patient data, a user module for storing registered medical practice account data; a provider module associated with the user module for storing provider data; a seminar module associated with the provider module for creating the seminars; and a report card module associated with the patient module for creating the report cards.

19. A method according to claim 18, wherein the computer program product is further configured to compare report card data to patient baseline data to determine patient outcome.

20. A method according to claim 12, wherein the computer program product includes a reporting module including a patient module for storing patient data; a reports module associated with the patient module for creating reports; and a user module associated with the patient and reports module for storing registered medical practice account data.
